(19) United States
(12) Patent Application Publication
(10) Pub. No.: US 2010/0027616 A1
(43) Pub. Date: Feb. 4, 2010

(54) SYMBOL-SHARING DIFFERENTIAL PULSE CODE MODULATION ENCODER/DECODER, MULTI-TIME DIFFERENTIAL PULSE CODE MODULATION ENCODER, IMAGE ENCODING/DECODING SYSTEM AND METHOD THEREOF

(76) Inventors: WEN MIN LU, Hsin Chu City (TW); MING-SUNG HUANG, Hsin Chu County (TW); CHIEN-CHOU CHEN, Chang Hua City (TW)

Correspondence Address: Muncy, Geissler, Olds & Lowe, PLLC, P.O. BOX 1364, FAIRFAX, VA, 22038-1364, US

(21) Appl. No.: 12/423,391

(22) Filed: Apr. 14, 2009

(30) Foreign Application Priority Data
Jul. 30, 2008 (TW) 097128733

(51) Int. Cl. H04N 11/04; G06K 9/36

(52) U.S. Cl. 375/240.01; 382/246

(57) ABSTRACT

A symbol-sharing differential pulse code modulation (DPCM) encoder is disclosed. Since the bit widths of DPCM encoded data are truncated in hardware to avoid overflow and symbols are shared in software, the DPCM encoded data have the same number of symbols as original input data do, which effectively reduces symbol lengths and average code length of the output data generated by a Huffman encoder at a rear stage.

This application claims the benefit of the filing date of Taiwan Application Ser. No. 097128733, filed on Jul. 30, 2008, the content of which is incorporated herein by reference.

### BACKGROUND OF THE INVENTION

1. Field of the Invention

The invention relates to image compression, particularly to a symbol-sharing differential pulse code modulation (DPCM), a multiple differential pulse code modulation, an image encoding/decoding system.

2. Description of the Related Art

Conventionally, differential pulse code modulation is a procedure of encoding differences between successive pixels. Assuming that an original pixel data has a n-bit length, its corresponding DPCM encoded pixel data will have a (n+1)-bit length according to prior arts, where the additional bit is the sign bit. Accordingly, even though DPCM encoded data usually concentrate at about zero (e.g., in the range of (−2) to 2), the DPCM encoded data will double the amount of original data. Besides, after the DPCM encoded data are further encoded by Huffman coding, the generated Huffman encoded data will have longer code length, thereby increasing the amount of Huffman encoded data, increasing the average code length and reducing compression rates.

On the other hand, three RGB components are respectively encoded by DPCM during image compression according to prior arts. In other words, a correlation between successive pixels with respect to a single color is usually used to concentrate encoded data. However, the distribution of the DPCM encoded data with respect to a single color is not concentrated sufficiently to make it clear that the average code length of the Huffman encoded data is reduced. Accordingly, what is needed is a method and device to address the above-identified problems. The invention addresses such a need.

### SUMMARY OF THE INVENTION

In view of the above-mentioned problems, an object of the invention is to provide a symbol-sharing DPCM encoder, which truncates its output to the same bit widths as its input, thereby achieving an effect of sharing symbols.

In order to achieve the above objectives, the invention provides a method of symbol-sharing differential pulse code modulation (DPCM) for receiving an M-bit input pixel sequence and generating an M-bit encoded sequence, the method comprising the steps of: setting the 0^{th} element Y[0] of the M-bit encoded sequence to the 0^{th} element X[0] of the M-bit input sequence; comparing the n^{th} element X[n] with the (n−1)^{th} element X[n−1]; If X[n] is greater than or equal to X[n−1], the n^{th} element Y[n] of the M-bit encoded sequence is equal to the n^{th} element X[n] minus the (n−1)^{th} element X[n−1]; and, If X[n] is less than X[n−1], the n^{th} element Y[n] of the M-bit encoded sequence is equal to the n^{th} element X[n] minus the (n−1)^{th} element X[n−1] plus 2^{M}, where M and n are positive integers; wherein the M-bit encoded sequence comprises 2^{M} different symbols.

Another object of the invention is to provide a method of symbol-sharing differential pulse code demodulation for receiving an M-bit encoded sequence and generating an M-bit pixel sequence, the method comprising the steps of: setting the 0^{th} element X[0] of the M-bit pixel sequence to the 0^{th} element Y[0] of the M-bit encoded sequence; adding the n^{th} element Y[n] of the M-bit encoded sequence and the (n−1)^{th} element X[n−1] of the M-bit pixel sequence to obtain the n^{th} element X[n] of the M-bit pixel sequence; comparing the n^{th} element X[n] with 2^{M}; and, if X[n] is greater than or equal to 2^{M}, selecting the M least significant bits out of X[n] as the n^{th} element X′ [n] of the M-bit pixel sequence, where M and n are positive integers; wherein the M-bit encoded sequence includes 2^{M} different symbols.

Another object of the invention is to provide an image encoding system for receiving a pixel sequence and generating an output encoded sequence, comprising: a buffer for temporarily storing a predetermined number of pixels of the pixel sequence; an encoding circuit coupled to the buffer for performing one-time DPCM encoding and multi-time DPCM encoding on the predetermined number of pixels to generate R Huffman encoded sequences; a multiplexer coupled to the encoding circuit for selecting one sequence as the output encoded sequence from the R Huffman encoded sequences according to a control signal; and, a decision circuit for performing one-time DPCM encoding and multi-time DPCM encoding and performing accumulation of Huffman code lengths relating the predetermined number of pixels to generate the control signal; wherein the control signal is generated before the R Huffman encoded sequences arrives at the multiplexer.

Another object of the invention is to provide an image decoding system for receiving an image encoded package and generating an output pixel sequence, comprising: a header detaching circuit for splitting the image encoded package into a header and an encoded sequence; a Huffman decoder for performing Huffman decoding on the encoded sequence to generate a Huffman decoded sequence; a multi-time DPCM decoding device for performing one-time DPCM decoding and (R−1) different kinds of multi-time DPCM decoding on the Huffman decoded sequence to generate R DPCM decoded sequences, where R is a positive integer; and, a multiplexer for selecting one sequence as the output pixel sequence from the R DPCM decoded sequences according to the header. Another object of the invention is to provide a method of multi-time differential pulse code modulation, comprising: receiving P data sequences simultaneously; performing one-time DPCM encoding on the P data sequences respectively to generate a one-time DPCM encoded sequence; and, performing parallel subtraction operations Q times at most on the one-time DPCM encoded sequence to generate (R−1) multi-time DPCM encoded sequences, where P, Q and R are positive integers, P>1, 0<Q<P, R=1+P+P×(P−1)+ . . . +P×(P−1)×(P−2)× . . . ×(P−Q+1).

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart of a symbol-sharing differential pulse code modulation method according to an embodiment of the invention.

FIG. 2 is a flow chart of a symbol-sharing differential pulse code demodulation method according to an embodiment of the invention.

FIG. 3 is a circuit diagram of a symbol-sharing DPCM encoder according to an embodiment of the invention.

FIG. 4 is a circuit diagram of a symbol-sharing DPCM decoder according to an embodiment of the invention.

FIG. 5 is a circuit diagram of a multi-time DPCM encoding device according to an embodiment of the invention.

FIG. 6 shows exemplary normal distributions of multi-time DPCM encoded sequences according to the invention.

FIG. 7 is a circuit diagram of an image encoding system according to an embodiment of the invention.

FIG. 8 is a circuit diagram of an image decoding system according to an embodiment of the invention.

FIG. 9 is a flow chart of an image encoding method according to an embodiment of the invention.

FIG. 10 is a flow chart of an image decoding method according to an embodiment of the invention.

### DETAILED DESCRIPTION OF THE INVENTION

The apparatus in accordance with the present invention may be hardware, software, or a combination of hardware and software (or firmware). An example of a pure solution would be an FPGA or ASIC design. An example of a hardware and software implementation would be a DSP and embedded firmware.

According to a symbol-sharing DPCM of the invention, the following two features are provided: the bit widths of DPCM encoded data are truncated in hardware to avoid overflow and symbols are shared in software. This allows the DPCM encoded symbols and the original input data to have the equal number of symbols. Thus, the symbol lengths and average code length of the output data generated by a Huffman encoder at a rear stage can be reduced effectively.

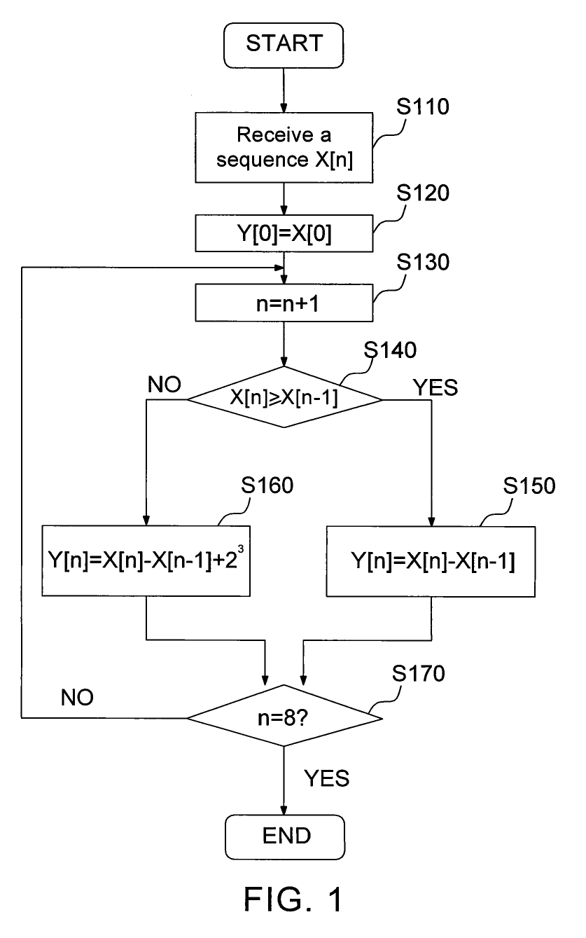

FIG. 1 is a flow chart of a symbol-sharing differential pulse code modulation method according to an embodiment of the invention. The method of symbol-sharing differential pulse code modulation is described in accordance with FIG. 1.

Step S110: Receive a three-bit input sequence X[n]. Assuming that the three-bit input pixel sequence X[n] contains nine elements (0≦n≦8), the sequence X[n] is expressed in binary digits as follows: {000, 001, 010, 100, 101, 110, 101, 100, 111}. If the sequence X[n] is encoded by conventional DPCM, the conventional DPCM encoded elements in a decimal format will be as follows: {0, 1, 1, 2, 1, 1, −1, −1, 3}. Obviously, the conventional DPCM encoded elements having a bit width of four are in the range of (−7) to (+7), having up to fifteen symbols.

Step S120: Set the 0^{th} element Y[0] of the DPCM encoded three-bit sequence to the 0^{th} element X[0] of the three-bit input sequence X[n], i.e., Y[0]=X[0].

Step S130: Increment n by 1, i.e., n=n+1.

Step S140: Compare the n^{th} element X[n] with the (n−1)^{th} element X[n−1]. If X[n]≧X[n−1], the flow goes to the step S150; otherwise, the flow goes to the step S160.

Step S150: If X[n]≧X[n−1], Y[n]=X[n]−X[n−1].

Step S160: If X[n]<X[n−1], Y[n]=X[n]−X[n−1]+2³.

Step S170: Determine whether the n value is equal to 8. If YES, the flow is completed; otherwise, the flow returns to the step S130.

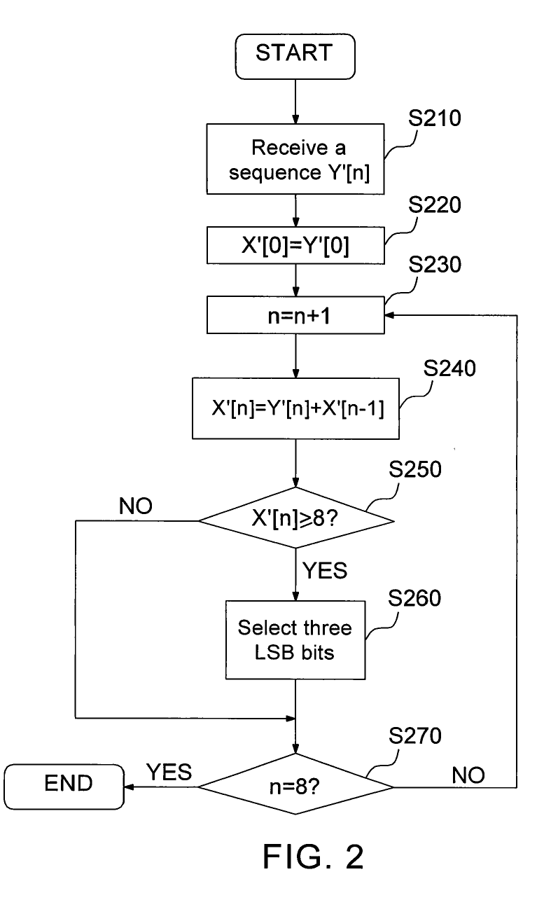

With respect to three-bit input data sequence, the symbol-sharing DPCM encoded data of the invention share common symbols. For example, (+7) is a common symbol for the values (+7) and (−1); (+6) is a common symbol for the values (+6) and (−2); (+5) is a common symbol for the values (+5) and (−3); (+4) is a common symbol for the values (+4) and (−4); (+3) is a common symbol for the values (+3) and (−5); (+2) is a common symbol for the values (+2) and (−6); (+1) is a common symbol for the values (+1) and (−7); the value (0) uses a unique symbol (0). As can be observed from the above common symbols, according to the invention, the negative values are replaced with their corresponding positive values. Thus, the nine elements of the symbol-sharing DPCM encoded three-bit sequence Y[n] are as follows: {0, 1, 1, 2, 1, 1, 7, 7, 3}. The bit widths of the elements of the sequence Y[n] remain three-bit and cover a range of (0) to (+7); besides, by comparison with the conventional DPCM, the symbol-sharing DPCM encoded three-bit sequence has about half the number of symbols (decreasing from 15 to 8). If (X[n]−X[n−1]) is a negative value, 2³ will be added to cause (X[n]−X[n−1]+2³) to become a positive value, thereby achieving the effect of sharing symbols. The invention produces a nearly 50% reduction in the number of symbols compared with prior arts. Thus, symbol lengths and average code length of the output data generated by a Huffman encoder at a rear stage can be reduced effectively to thereby obtain a much higher compression rate. In practical applications, a symbol-sharing differential pulse code demodulation method, as shown in FIG. 2, is required to decode the above symbol-sharing DPCM encoded three-bit sequence Y[n]. FIG. 2 is a flow chart of a symbol-sharing differential pulse code demodulation method according to an embodiment of the invention. The method of symbol-sharing differential pulse code demodulation is described below in accordance with FIGS. 1 and 2.

According to the embodiment of FIG. 1, the nine elements of the symbol-sharing DPCM encoded three-bit sequence Y[n] are as follows: {0, 1, 1, 2, 1, 1, 7, 7, 3}. After lossless Huffman coding and lossless Huffman decoding are performed on the symbol-sharing DPCM encoded three-bit sequence Y[n], a Huffman decoded sequence Y[n] is obtained as follows: {0, 1, 1, 2, 1, 7, 7, 3}.

Step S210: Receive a three-bit Huffman decoded sequence Y′[n].

Step S220: Set the 0^{th} element X′[0] of the symbol-sharing DPCM decoded three-bit sequence X′[n] to the 0^{th} element Y′[0] of the three-bit Huffman decoded sequence Y[n], i.e., X′[0]=Y′[0].

Step S230: Increment n by 1, i.e., n=n+1.

Step S240: X′[n]=Y′[n]+X′[n−1], if n≠0. In this step, nine elements of the symbol-sharing DPCM decoded three-bit sequence X′[n] in decimal form are obtained as follows: {0, 1, 2, 4, 5, 6, 13, 20, 23}, whereas the same sequence X′[n] in binary form is as follows: {000, 001, 010, 100, 101, 110, 1101, 10100, 10111}.

Step S250: Determine whether X[n] is greater than or equal to eight. That is, determine whether X[n] is overflowed. If YES, the flow goes to the step S260; otherwise, the flow goes to the step S270.

Step S260: Select the three LSB (least significant bit) bits out of X′[n], if X′[n] is greater than or equal to eight. Since the bit width of each element of the sequence X′[n] is three, the overflowed bit (i.e., most significant bit (MSB)) will be discarded if overflow happens. Accordingly, the symbol-sharing DPCM decoded three-bit sequence X[n] in binary form finally obtained is as follows: {000, 001, 010, 100, 101, 110, 101, 100, 111}, equivalent to the three-bit input sequence X[n].

Step S270: Determine whether the n value is equal to 8. If YES, the flow is completed; otherwise, the flow returns to the step S230.

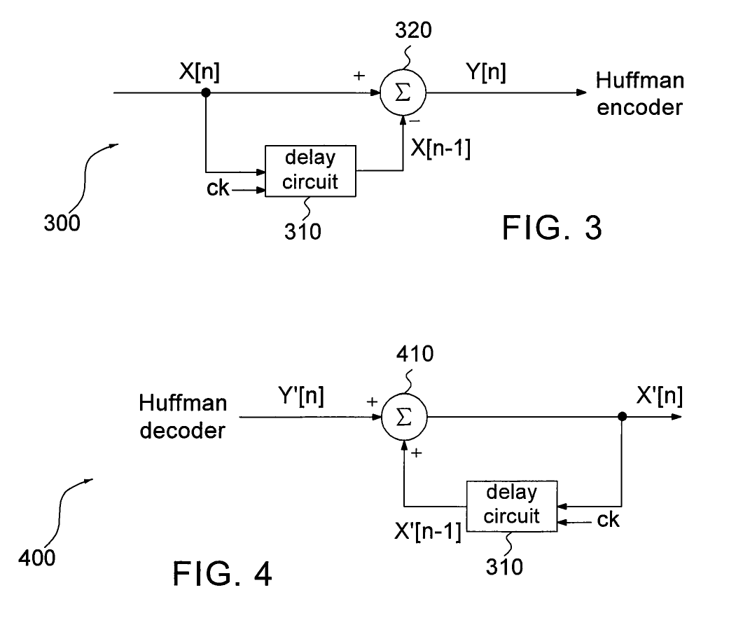

FIG. 3 is a circuit diagram of a symbol-sharing DPCM encoder according to an embodiment of the invention. Referring to FIG. 3, the symbol-sharing DPCM encoder 300 of the invention is provided to receive a three-bit input sequence X[n] (the above sequence X[n] containing nine elements is taken as an example) so as to generate a symbol-sharing DPCM encoded three-bit sequence Y[n]. The encoder 300 includes a delay circuit 310 and a subtractor 320. According to a pixel clock signal ck, the delay circuit 310 delays the three-bit input sequence X[n] by a pixel clock period to generate a three-bit delayed sequence X[n−1], where n is a positive integer and X[−1]=0. The subtractor 320 subtracts the delayed sequence X[n−1] from the input sequence X[n] and then generates the symbol-sharing DPCM encoded three-bit sequence Y[n]. According to the invention, the subtractor 320 is provided to truncate its output to a fixed bit width of three to avoid overflow in hardware, thereby achieving an effect of sharing symbols. In other words, the output Y[n] of the subtractor 320 is truncated to the same bit widths as its two inputs X[n] and X[n−1]. The sequence Y[n] covers a range of (0) to (+7) and has eight symbols only. The implementation of the subtractor 320 is well known to those skilled in the art and therefore will not be described herein.

FIG. 4 is a circuit diagram of a symbol-sharing DPCM decoder according to an embodiment of the invention. Referring to FIG. 4, the symbol-sharing DPCM decoder 400 of the invention is provided to receive a three-bit sequence Y′[n] (the above sequence Y′[n] is taken as an example, containing the following nine elements {0, 1, 1, 2, 1, 1, 7, 7, 3}) so as to generate a symbol-sharing DPCM decoded three-bit sequence X′[n]. The decoder 400 includes a delay circuit 310 and an adder 410. According to a pixel clock signal ck, the delay circuit 310 delays the three-bit sequence X′[n] by a pixel clock period to generate a three-bit delayed sequence X′[n−1], where n is a positive integer and X[−1]=0. The adder 410 adds the delayed sequence X′[n−1] with the sequence Y′[n] and then generates the symbol-sharing DPCM decoded three-bit sequence X′[n]. According to the invention, the adder 410 is provided to truncate its output to a fixed bit width of three to avoid overflow in hardware, thereby restoring the correct three-bit sequence X′[n]. In other words, the output X′[n] of the adder 410 is truncated to the same bit widths as its two inputs X′[n−1] and Y′[n]. The implementation of the adder 410 is well known to those skilled in the art and therefore will not be described herein.

Throughout the specification and claims, the following terms take the meanings explicitly associated herein, unless the context clearly dictates otherwise. The term “one-time DPCM encoding” refers to a series of serial subtraction operations having a 0^{th} element as the reference value, whereas the term “one-time DPCM decoding” refers to a series of serial addition operations having its 0^{th} element as the reference value. Accordingly, the one-time DPCM encoding/decoding is not limited to the above-mentioned symbol-sharing DPCM encoding/decoding but includes conventional DPCM encoding/decoding. In contrast, the term “multi-time DPCM encoding” refers to parallel subtraction operations having a basis sequence as the reference sequence, whereas the term “multi-time DPCM decoding” refers to parallel addition operations having the basis sequence as the reference sequence. A multi-time differential pulse code modulation encoder/decoder and method thereof that will be discussed below is applicable to multiple-channel input sequences.

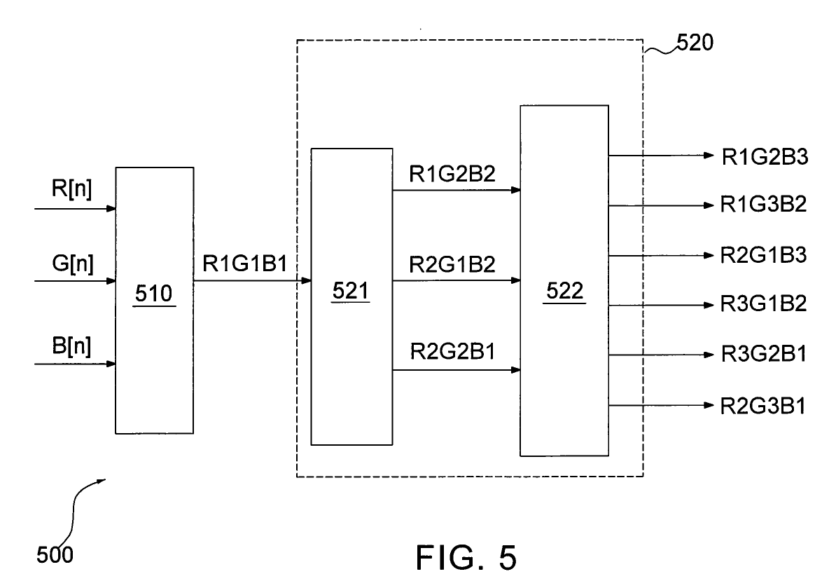

FIG. 5 is a circuit diagram of a multi-time DPCM encoding device according to an embodiment of the invention. Referring to FIG. 5, the multi-time DPCM encoding device 500 of the invention includes a one-time DPCM encoder 510 and a multi-time DPCM encoder string 520 where the multi-time DPCM encoder string 520 includes a two-time DPCM encoder 521 and a three-time DPCM encoder 522.

After receiving three four-bit input sequences R[n], G[n] and B[n], the one-time DPCM encoder 510 performs one-time conventional DPCM encoding on the sequences R[n], G[n] and B[n] respectively and then generates a one-time DPCM encoded sequences R1[n]G1[n]B1[n] (which hereinafter is called R1G1B1 in short). Assuming that three four-bit input sequences are as follows: R[n]={5, 6, 7, 8, 9, 6, 5, 2, 4, 1}, G[n]={8, 6, 7, 6, 9, 6, 5, 2, 4, 2} and B[n]={8, 6, 5, 8, 9, 6, 5, 2, 4, 1}, three one-time DPCM encoded sequences will be as follows: R1[n]={5, 1, 1, 1, 1, −3, −1, −3, 2, −3}, G1[n]={8, −2, 1, 1, 3, −3, −1, −3, 2, −2} and B1[n]={8, −2, −1, 3, 1, −3, −1, −3, 2, −3}. In an alternative embodiment, the one-time DPCM encoder 510 performs the above symbol-sharing DPCM encoding on the sequences R[n], G[n] and B[n] respectively to generate a one-time DPCM encoded sequences R1[n]G1[n]B1[n].

Next, the two-time DPCM encoder 521 performs two-time DPCM encoding on the one-time DPCM encoded sequences R1[n], G1[n] and B1[n] and then generates two-time DPCM encoded sequences R1[n]G2[n]B2[n], R2[n]G1[n]B2[n] and R2[n]G2[n]B1[n] (which hereinafter are called R1G2B2, R2G1B2 and R2G2B1 in short). A combination of R1G2B2 is a corresponding output generated by the two-time DPCM encoder 521 having the sequence R1[n] as the basis sequence and performing two-time DPCM encoding on the sequences G1[n] and B1[n]. That is, the two-time DPCM encoder 521 has the sequence R1[n] as the basis sequence and then performs parallel subtraction operations on the sequences G1[n] and B1[n] (i.e., G2[n]=G1[n]−R1[n], B2[n]=B1[n]−R1[n]) to generate the following two-time DPCM encoded sequences: G2[n]={3, −3, 0, 0, 2, 0, 0, 0, 0, 1} and B2[n]={3, −3, 0, 0, 2, 0, 0, 0, 0, 1}. A combination of R2G1 B2 is a corresponding output generated by the two-time DPCM encoder 521 having the sequence G1[n] as the basis sequence and performing two-time DPCM encoding on the sequences R1[n] and B1[n]. That is, the two-time DPCM encoder 521 has the sequence G1[n] as the basis sequence and then performs parallel subtraction operations on the sequences R1[n] and B1[n] (i.e., R2[n]=R1[n]−G1[n], B2[n]=B1[n]−G1[n]) to generate the following two-time DPCM encoded sequences: R2[n]={−3, 3, 0, 0, −2, 0, 0, 0, 0, −1} and B2[n]={0, 0, −2, 2, −2, 0, 0, 0, 0, −1}. A combination of R2G2B1 is a corresponding output generated by the two-time DPCM encoder 521 having the sequence B1[n] as the basis sequence and performing two-time DPCM encoding on the sequences R1[n] and G1[n]. That is, the two-time DPCM encoder 521 has the sequence B1[n] as the basis sequence and then performs parallel subtraction operations on the sequences R1[n] and G1[n] (i.e., R2[n]=R1[n]−B1[n], G2[n]=G1[n]−B1[n]) to generate the following two-time DPCM encoded sequences: R2[n]={−3, 3, 2, −2, 0, 0, 0, 0, 0, 0} and G2[n]={0, 0, 2, −2, 2, 0, 0, 0, 0, 1}.

The three-time DPCM encoder 522 performs three-time DPCM encoding on the two-time DPCM encoded sequences R1G2B2, R2G1B2 and R2G2B1 respectively and then generates three-time DPCM encoded sequences R1G2B3, R1G3B2, R2G1B3, R3G1B2, R2G3B1 and R3G2B1 (a total of six combinations). Regarding the input sequences R1G2B2, the three-time DPCM encoder 522 does not deal with the sequence R1[n] but have the sequence G2[n] as the basis sequence to perform three-time DPCM encoding on the sequence B2[n]. That is, the three-time DPCM encoder 522 has the sequence G2[n] as the basis sequence and then performs parallel subtraction operations on the sequence B2[n] (i.e., G3[n]=G2[n]−B2[n]) to generate the three-time DPCM encoded sequence: G3[n]={0, 0, 2, −2, 2, 0, 0, 0, 0, 1}. Accordingly, after performing three-time DPCM encoding on the two-time DPCM encoded sequences R1G2B2, the three-time DPCM encoder 522 correspondingly generates three-time DPCM encoded sequences R1G2B3 and R1G3B2. As such, after performing three-time DPCM encoding on the two-time DPCM encoded sequences R2G1B2, the three-time DPCM encoder 522 correspondingly generates three-time DPCM encoded sequences R2G1B3 and R3G1B2. Likewise, after performing three-time DPCM encoding on the two-time DPCM encoded sequences R2G2B1, the three-time DPCM encoder 522 correspondingly generates three-time DPCM encoded sequences R2G3B1 and R3G2B1. In comparison to the one-time DPCM encoding, each of the two-time DPCM encoding and the three-time DPCM encoding performs parallel subtraction operations.

It should be noted that the maximum number of times that the multi-time DPCM encoding device 500 is allowed to perform DPCM encoding is equal to the number of input sequences supplied to the multi-time DPCM encoding device 500. Assuming that the number of input sequences supplied to the multi-time DPCM encoding device 500 is P, the maximum number of times that the multi-time DPCM encoding device 500 is allowed to perform DPCM encoding will be equal to P and there are (P!) combinations in the P-time DPCM encoded sequences. The multi-time DPCM encoding device 500 generates a total of R DPCM encoded sequences (R combinations), including a one-time DPCM encoded sequence, P two-time DPCM encoded sequences, (P×(P−1)) three-time DPCM encoded sequences, . . . , and (P×(P−1)×(P−2) . . . ×(P−Q+1))(Q+1)-time DPCM encoded sequences, where Q and P are positive integers and Q<P, R=1+P+P×(P−1)+ . . . +P×(P−1)×(P−2) . . . ×(P−Q+1).

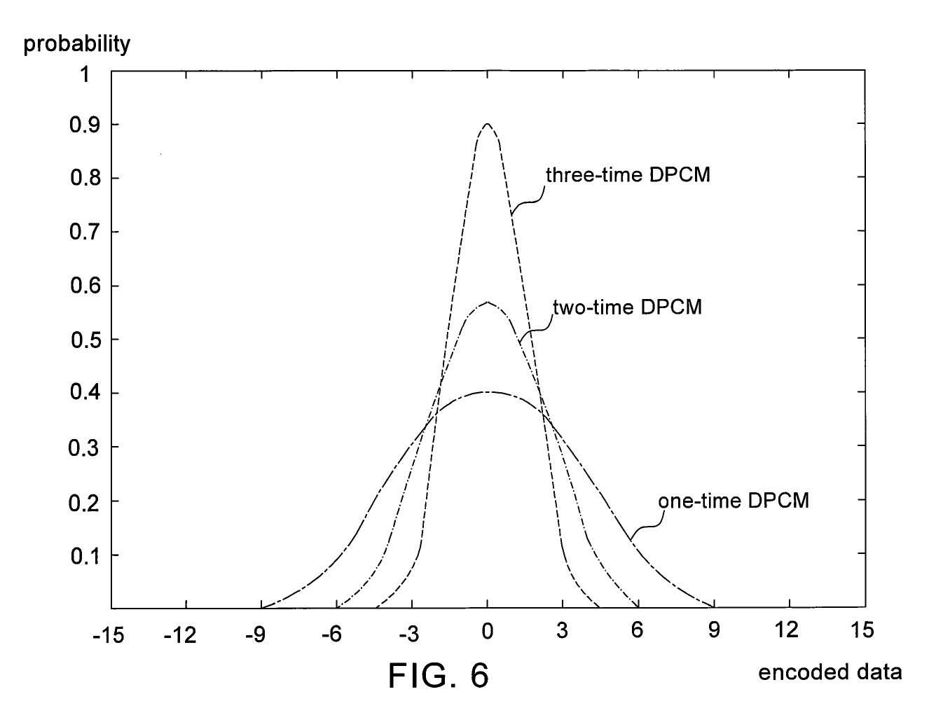

The multi-time DPCM encoding device 500 of the invention uses highly correlated image sequences in the RGB domain to perform multi-time DPCM encoding. In comparison to the one-time DPCM encoded sequence, a multi-time DPCM encoded sequence is usually more concentrated at about zero; in addition, the encoded sequence will be getting more concentrated at about zero as the DPCM encoding is performed one more time. FIG. 6 shows exemplary normal distributions of the multi-time DPCM encoded sequences according to the invention. Referring to FIG. 6, the vertical axis represents probability while the horizontal axis represents the numeric range of encoded data. There are three normal distribution curves denoting a one-time DPCM encoded sequence, a two-time DPCM encoded sequence and a three-time DPCM encoded sequence. As can be observed from FIG. 6, the more the number of times that the DPCM encoding is performed, the more the DPCM encoded sequence will be concentrated at about zero. Therefore, the symbol lengths and average code length of the output data generated by a Huffman encoder at a rear stage are reduced effectively and a much higher compression rate is obtained.

In practice, even though the number of input sequences is P, it is not necessary for the multi-time DPCM encoding device 500 to perform the DPCM encoding up to P times; in fact, as long as the DPCM encoding is performed at least two times, the effect of concentrating the encoded data will be significant. Thus, circuit designer may design different numbers of stages (i.e., the number of times that the DPCM encoding is performed) in the multi-time DPCM encoding device 500 depending on the hardware cost and efficiency needs. Further, the one-time DPCM encoder 510 may perform a conventional DPCM encoding (that is, an input sample has a n-bit length and its corresponding encoded data have a (n+1)-bit length with an additional sign bit) or may be implemented using the symbol-sharing DPCM encoder 300 of the invention. Obviously, if the one-time DPCM encoder 510 is implemented using the symbol-sharing DPCM encoder 300, the multi-time DPCM encoding device 500 will create a more positive effect of concentrating the encoded data and reducing the average code length of the Huffman encoded data.

As previously discussed, the one-time DPCM encoding refers to serial subtraction operations having the 0^{th} element as the reference value and each of the two-time DPCM encoding and the multi-time DPCM encoding refers to parallel subtraction operations having the basis sequence as the reference sequence. Accordingly, since the decoding process is an inverse process of the encoding process, the original image pixels can be restored during decoding as long as the inverse operations (e.g., serial addition operations or parallel addition operations) are performed using the reference value (or the reference sequence).

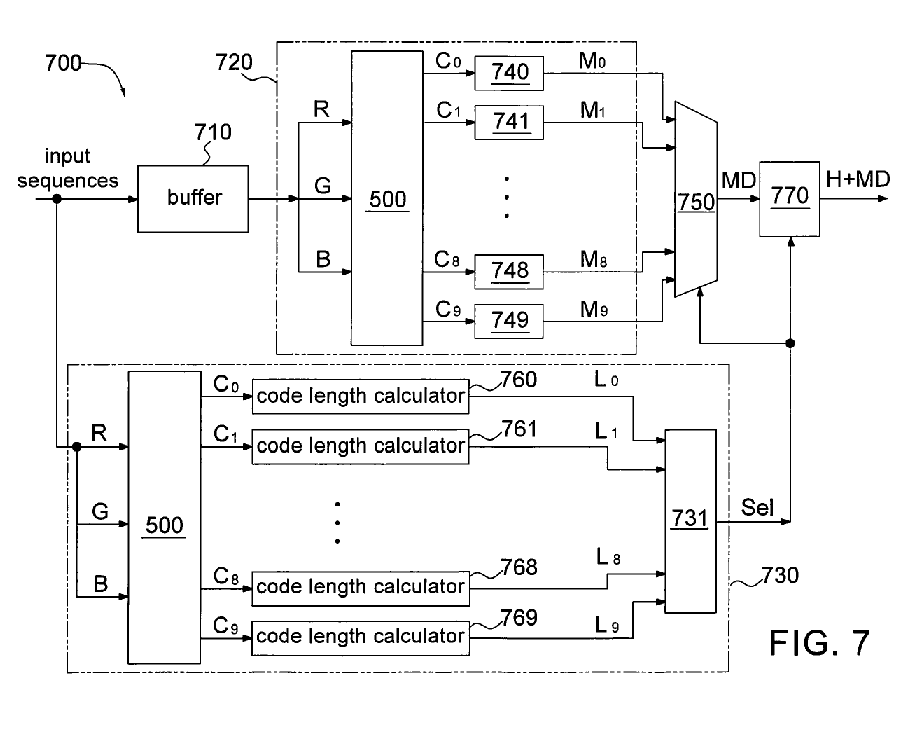

FIG. 7 is a circuit diagram of an image encoding system according to an embodiment of the invention. Referring to FIG. 7, the image encoding system 700 of the invention includes a buffer 710, an encoding circuit 720, a decision circuit 730, a header attaching circuit 770 and a multiplexer 750. The buffer 710 stores pixel data temporarily and its capacity depends on both the amount of data that the decision circuit 730 processes at one time and the processing rate limit of the encoding circuit 720 and the decision circuit 730. For example, assuming that the decision circuit 730 processes 64 pixels at one time, it takes five pixel clock periods for the encoding circuit 720 to complete processing and it takes five pixel clock periods for decision circuit 730 to complete processing, the capacity of the buffer 710 is required to store at least 69 (=64+10−5) pixel data.

The encoding circuit 720 receives a pre-determined number of pixels (assuming that 64 pixels are processed at one time and each pixel includes R, G, B components, there are three input pixel sequences R[n], G[n] and B[n]), performs multi-time DPCM encoding and Huffman encoding and then generates ten (=1+3+6) Huffman encoded sequences. The decision circuit 730 receives the same data as the encoding circuit 720 does. The decision circuit 730 calculates ten Huffman encoded lengths L₀˜L₉ with respect to ten Huffman encoded sequences M₀˜M₉ and selects the minimum sum of Huffman code lengths (i.e., having the highest compression rate) from the ten Huffman encoded lengths L₀˜L₉ to generate a corresponding control signal Sel. Next, according to the control signal Sel, the multiplexer 750 selects one sequence from the ten Huffman encoded sequences M₀˜M₉ as the Huffman encoded sequence MD. Accordingly, a special requirement in hardware timing is that the decision circuit 730 must already generate the control signal Sel and send it to the multiplexer 750 for selecting a corresponding Huffman encoded sequence before the ten Huffman encoded sequences M₀˜M₉ arrive at the multiplexer 750.

The encoding circuit 720 includes a multi-time DPCM encoding device 500 and ten Huffman encoders 740˜749 while the decision circuit 730 includes a multi-time DPCM encoding device 500, ten Huffman code length calculators 760˜769 and a comparator 731. The encoding circuit 720 and the decision circuit 730 have similar hardware structures; however, a difference is that the decision circuit 730 does not perform a real Huffman encoding but calculate ten sums of Huffman encode lengths with respect to the ten Huffman encoded sequences M₀˜M₉ to determine a sequence having the minimum sum of Huffman code lengths from the ten Huffman encoded sequences M₀˜M₉. Since the implementation of the Huffman encoder and the Huffman code length calculator is well known to those skilled in the art and the multi-time DPCM encoding device 500 is discussed previously, the description is omitted herein.

Theoretically, the more the number of times that the DPCM encoding is performed, the more the DPCM encoded sequence is concentrated at about zero; however, exceptions occur in practical applications, so it is safe for the decision circuit 730 to check one one-time DPCM encoded sequence, two two-time DPCM encoded sequences and six three-time DPCM encoded sequences at one time, i.e., performing accumulation of Huffman code lengths on the ten DPCM coded sequences C₀˜C₉ simultaneously. Thus, in the encoding circuit 720, the multi-time DPCM encoding device 500 generates the ten DPCM coded sequences C₀˜C₉ and respectively sends them to the ten Huffman encoders 740˜749 for generating the ten Huffman encoded sequences M₀˜M₉. In contrast, in the decision circuit 730, the multi-time DPCM encoding device 500 generates the ten DPCM coded sequences C₀˜C₉ and respectively sends them to the ten Huffman code length calculators 760˜769 for generating ten code lengths L₀˜L₉. Afterward, the comparator 731 compares the ten lengths L₀˜L₉ and generates a corresponding control signal Sel indicating one of the ten Huffman encoded sequences M₀˜M₉ having the minimum length. Before the ten Huffman encoded sequences M₀˜M₉ arrive at the multiplexer 750, the control signal Sel is supplied to the multiplexer 750 for selecting a corresponding sequence from the ten Huffman encoded sequences M₀˜M₉ as the Huffman encoded sequence MD.

Moreover, before the Huffman encoded sequence MD is stored into the system memory (not shown), the header attaching circuit 770 will attach a header H to the beginning of the Huffman encoded sequence MD to form an image encoded package with an “H+MD” structure according to the control signal Sel. The individual header H of each image encoded package indicates that its payload (the Huffman encoded sequence MD) either is outputted from a specified output terminal of the multi-time DPCM encoding device 500 or corresponds to a specified RGB data combination. For example, a specified field in the header H having a value of 9 indicates that its payload either is outputted from a C9 terminal of the multi-time DPCM encoding device 500 or corresponds to a “R2G3B1” combination and thus will be referred in the decoding process. It should be noted that the header attaching circuit 770 is optional and attaching the header H to the beginning of the Huffman encoded sequence MD can be implemented using other methods. In an alternative embodiment, ten Huffman encoders 740˜749 are provided to further attach ten headers H to the ten Huffman encoded sequences M₀˜M₉ respectively to form ten image encoded packages with the “H+MD” structure, in addition to encoding the ten DPCM coded sequences C₀˜C₉ into the ten Huffman encoded sequences M₀˜M₉. Afterward, no matter which sequence the multiplexer 750 selects, the corresponding output image encoded package will be directly stored into the system memory.

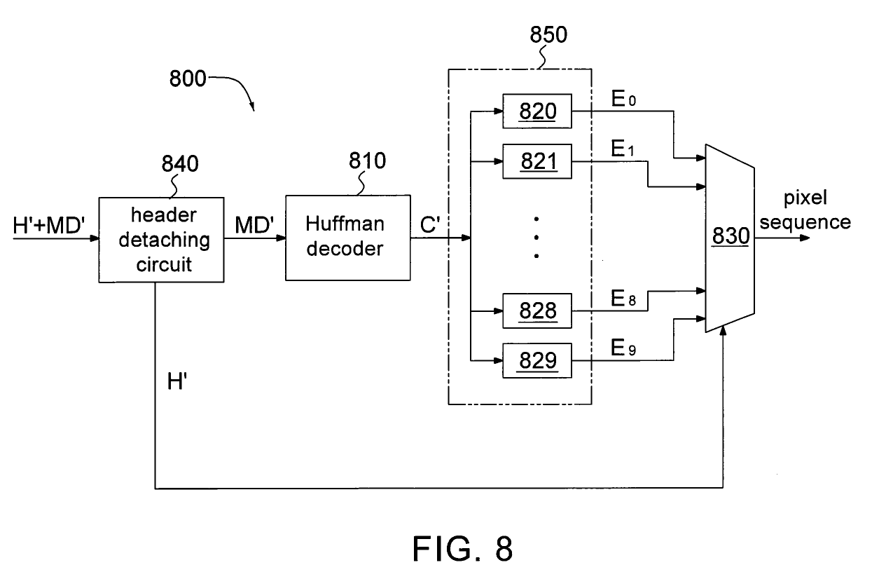

FIG. 8 is a circuit diagram of an image decoding system according to an embodiment of the invention. Referring to FIG. 8, the image decoding system 800 of the invention includes a Huffman decoder 810, a multi-time DPCM decoding device 850, a header detaching circuit 840 and a multiplexer 830. The header detaching circuit 840 detaches the header H′ from an input image encoded package with an “H′+MD′” structure and sends the header H′ and the encoded sequence MD′ to multiplexer 830 and the Huffman decoder 810 respectively. Then, the Huffman decoder 810 decodes the encoded sequence MD′ and generates a Huffman decoded sequence C′ to be sent to the multi-time DPCM decoding device 850.

Specifically, the multi-time DPCM decoding device 850 includes a one-time DPCM decoder 820 and nine multi-time DPCM decoders 821˜829 for performing ten different DPCM decoding. The ten different DPCM decoding operations are the inverse logic processes of the ten different DPCM encoding operations that the multi-time DPCM encoding device 500 performs to generate the ten DPCM coded sequences C₀˜C₉. For example, assuming that the Huffman decoded sequence C′ is a “R1G1B1” combination, the one-time DPCM decoder 820 needs to perform the one-time DPCM decoding only, i.e., serial addition operations, to restore the original sequences R[n], G[n] and B[n]. Further, assuming that the Huffman decoded sequence C′ is a “R2G3B1” combination, the multi-time DPCM decoder 829 needs to perform three-time DPCM decoding as follows. First, the multi-time DPCM decoder 829 has the sequence R2 as the basis sequence and performs parallel addition operations on the sequence G3 to obtain the decoded sequence G2 (=R2+G3). Next, the multi-time DPCM decoder 829 has the sequence B1 as the basis sequence and performs parallel addition operations on the sequences R2 and G2 to obtain the decoded sequences R1 (=B1+R2) and G1(=B1+G2). Finally, the multi-time DPCM decoder 829 performs serial addition operations on the sequences R1, G1 and B1 respectively to restore the original sequences R[n], G[n] and B[n]. Since each of the DPCM decoders 820˜829 has different decoding logic, only one DPCM decoded sequence among the ten DPCM decoded sequences E₀˜E₉ is correct after one single Huffman decoded sequence C is simultaneously sent to the ten DPCM decoders 820˜829 and decoded by ten DPCM decoders 820˜829. According to the embodiment, the multiplexer 830 selects one sequence as the output from the ten DPCM decoded sequences E₀˜E₉ according to the header H′.

It should be noted that the decoding logic of the one-time DPCM decoder 820 inversely corresponds to the encoding logic of the one-time DPCM encoder 510. In other words, if the one-time DPCM encoder 510 employs the conventional DPCM encoding, the one-time DPCM decoder 820 employs the conventional DPCM decoding; instead, if the one-time DPCM encoder 510 is implemented using the symbol-sharing DPCM encoder 300 of the invention, the one-time DPCM decoder 820 is implemented using the symbol-sharing DPCM decoder 400 of the invention.

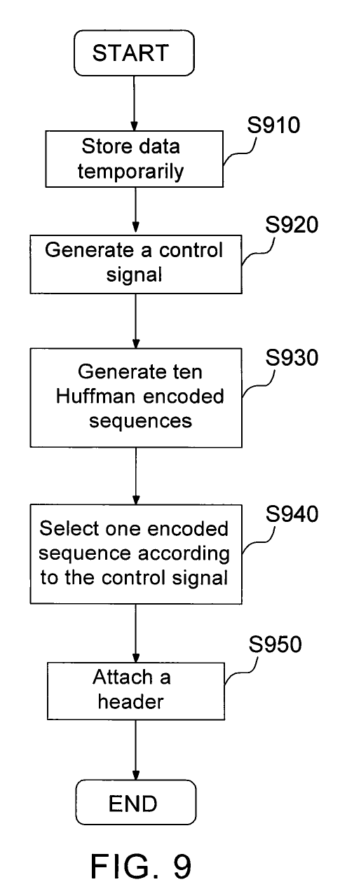

FIG. 9 is a flow chart of an image encoding method according to an embodiment of the invention. The image encoding method is described below in accordance with FIGS. 7 and 9.

Step S910: Store a predetermined number of pixels (assuming that 64 pixels are processed at one time and each pixel includes R, G, B components, there are three input pixel sequences R[n], G[n] and B[n]) into the buffer 710 temporarily.

Step S920: Generate a control signal Sel by performing one time DPCM encoding, multi-time DPCM encoding and accumulation of Huffman code lengths on the three input pixel sequences R[n], G[n] and B[n]. In the decision circuit 730, the multi-time DPCM encoding device 500 performs one time DPCM encoding and multi-time DPCM encoding on the input sequences R[n], G[n] and B[n] to generate the ten DPCM coded sequences C₀˜C₉. The ten Huffman code length calculators 760˜769 calculates the ten sums of Huffman code lengths relating the ten DPCM coded sequences C₀˜C₉ to generate the ten code lengths L₀˜L₉. Finally, the comparator 731 selects one sequence having the minimum length as the output sequence from the ten Huffman encoded sequences M₀˜M₉ to generate a corresponding control signal Sel.

Step S930: Generate ten Huffman encoded sequences M₀˜M₉ by performing one time DPCM encoding, multi-time DPCM encoding and Huffman encoding on the input sequences R[n], G[n] and B[n]. In the encoding circuit 730, the multi-time DPCM encoding device 500 performs one time DPCM encoding and multi-time DPCM encoding on the input sequences R[n], G[n] and B[n] to generate the ten DPCM coded sequences C₀˜C₉. The ten Huffman encoders 740˜749 performs Huffman encoding on the DPCM coded sequences C₀˜C₉ to generate ten Huffman encoded sequences M₀˜M₉.

Step S940: Select one encoded sequence as the Huffman encoded sequence MD from the ten Huffman encoded sequences M₀˜M₉. According to the control signal Sel, the multiplexer 750 selects a corresponding sequence from the ten Huffman encoded sequences M₀˜M₉ as the Huffman encoded sequence MD before the ten Huffman encoded sequences M₀˜M₉ arrive at the multiplexer 750.

Step S950: Attach the header H to the beginning of the Huffman encoded sequence MD to form an image encoded package with an “H+MD” structure. According to the control signal Sel, the header attaching circuit 770 attaches a corresponding header H to the beginning of the Huffman encoded sequence MD to form an image encoded package with an “H+MD” structure, where the header H contains decoding information. It should be noted that this step is optional. In an alternative embodiment, in the step S930, ten headers H are respectively attached to the beginnings of the ten Huffman encoded sequences M₀˜M₉ to form ten image encoded packages with the H+MD structures after the ten Huffman encoders 740˜749 encode the ten DPCM coded sequences C₀˜C₉ into the ten Huffman encoded sequences M₀˜M₉.

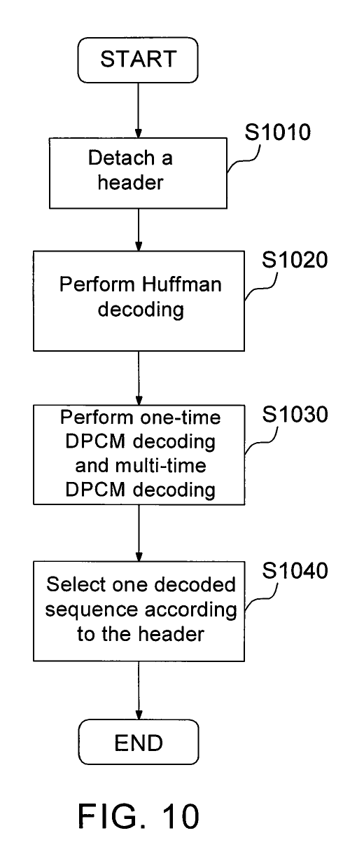

FIG. 10 is a flow chart of an image decoding method according to an embodiment of the invention. The image decoding method is described below in accordance with FIGS. 8 and 10.

Step S1010: Split an image encoded package with an “H′+MD′” structure into a header H′ and an encoded sequence MD′. The header detaching circuit 840 detaches the header H′ from an input image encoded package with the “H′+MD′” structure to generate the header H′ and the encoded sequence MD′.

Step S1020: Perform Huffman decoding on the encoded sequence MD′ to generate a Huffman decoded sequence C′. According to the encoded sequence MD′, the Huffman decoder 810 perform Huffman decoding to generate a Huffman decoded sequence C′.

Step S1030: Perform one-time DPCM decoding and nine different multi-time DPCM decoding on the encoded sequence MD′ to generate ten DPCM decoded sequences E₀˜E₉. Since each of the one-time DPCM decoder 820 and the multi-time DPCM decoders 821˜829 has different decoding logic, only one DPCM decoded sequence is correct among the ten DPCM decoded sequences E₀˜E₉ generated by the ten DPCM decoders 820˜829.

Step S1040: Select one sequence as the pixel sequence from the ten DPCM decoded sequences E₀˜E₉ according to the header H′. The multiplexer 830 selects one sequence as the pixel sequence from the ten DPCM decoded sequences E₀˜E₉ according to the header H′.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A method of symbol-sharing differential pulse code modulation (DPCM) for receiving an M-bit input pixel sequence and generating an M-bit encoded sequence, the method comprising the steps of:
setting the 0^{th} element Y[0] of the M-bit encoded sequence to the 0^{th} element X[0] of the M-bit input sequence;
comparing the n^{th} element X[n] with the (n−1)^{th} element X[n−1];
If X[n] is greater than or equal to X[n−1], the n^{th} element Y[n] of the M-bit encoded sequence is equal to the n^{th} element X[n] minus the (n−1)^{th} element X[n−1]; and
If X[n] is less than X[n−1], the n^{th} element Y[n] of the M-bit encoded sequence is equal to the n^{th} element X[n] minus the (n−1)^{th} element X[n−1] plus 2^{M}, where M and n are positive integers;
wherein the M-bit encoded sequence comprises 2^{M} different symbols.

2. A symbol-sharing DPCM encoder for receiving an M-bit input pixel sequence and generating an M-bit encoded sequence, comprising:
a delay circuit for delaying the n^{th} element X[n] of the M-bit input sequence by a clock period to generate a M-bit delayed data X[n−1] according to a clock signal; and
a subtractor coupled to the delay circuit for subtracting the M-bit delayed data X[n−1] from the n^{th} element X[n] of the M-bit input sequence to generate the n^{th} element Y[n] of the M-bit encoded sequence, where M is a positive integer and n is greater than or equal to zero;
wherein the M-bit encoded sequence comprises 2^{M} different symbols and X[−1]=0.

3. A symbol-sharing DPCM decoder for receiving an M-bit encoded sequence and generating an M-bit pixel sequence, comprising:
an adder for adding the n^{th} element Y′ [n] of the M-bit encoded sequence and a M-bit delayed data X′[n−1] to generate the n^{th} element X′[n] of the M-bit pixel sequence; and
a delay circuit coupled to the adder for delaying the n^{th} element X′[n] of the M-bit pixel sequence by a clock period to generate the M-bit delayed data X′[n−1] according to a clock signal, wherein M is a positive integer, n is an integer and n≧0;
wherein the M-bit encoded sequence includes 2^{M} different symbols and X′[−1]=0.

4. A method of symbol-sharing differential pulse code demodulation for receiving an M-bit encoded sequence and generating an M-bit pixel sequence, the method comprising the steps of:
setting the 0^{th} element X′[0] of the M-bit pixel sequence to the 0^{th} element Y′[0] of the M-bit encoded sequence;
adding the n^{th} element Y′[n] of the M-bit encoded sequence and the (n−1)^{th} element X′[n−1] of the M-bit pixel sequence to obtain the n^{th} element X′[n] of the M-bit pixel sequence;
comparing the n^{th} element X′[n] with 2^{M}; and
if X′[n] is greater than or equal to 2^{M}, selecting the M least significant bits out of X′[n] as the n^{th} element X′[n] of the M-bit pixel sequence, where M and n are positive integers;
wherein the M-bit encoded sequence includes 2^{M} different symbols.

5. An image encoding method for receiving a pixel sequence and generating an output encoded sequence, the method comprising the steps of:
performing one-time DPCM encoding, multi-time DPCM encoding and accumulation of Huffman code lengths on a predetermined number of pixels of the pixel sequence to generate a control signal;
performing one-time DPCM encoding, multi-time DPCM encoding and Huffman encoding on the predetermined number of pixels of the pixel sequence to generate R Huffman encoded sequences; and
selecting one sequence as the output encoded sequence from the R Huffman encoded sequences according to the control signal.

6. The method according to claim 5, wherein the step of performing one-time DPCM encoding, multi-time DPCM encoding and accumulation of Huffman code lengths comprises:
receiving the predetermined number of pixels, wherein the predetermined number of pixels is split into P data sequences;
performing one-time DPCM encoding on the P data sequences to generate a one-time DPCM encoded sequence;
performing parallel subtraction operations Q times at most on the one-time DPCM encoded sequence to generate (R−1) multi-time DPCM encoded sequences, wherein P, Q and R are positive integers, P>1, 0<Q<P and R=1+P+P×(P−1)+ . . . +P×(P−1)×(P−2) . . . ×(P−Q+1);
performing accumulation of Huffman code lengths relating the one-time DPCM encoded sequence and the (R−1) multi-time DPCM encoded sequences to generate R code lengths; and
generating the control signal according to the R code lengths.

7. The method according to claim 6, wherein the step of performing one-time DPCM encoding further comprises:
performing one-time DPCM encoding on the P data sequences to generate the one-time DPCM encoded sequence according to a symbol-sharing DPCM method.

8. The method according to claim 5, wherein the step of performing one-time DPCM encoding, multi-time DPCM encoding and Huffman encoding comprises:
receiving the predetermined number of pixels, wherein the predetermined number of pixels is split into P data sequences;
performing one-time DPCM encoding on the P data sequences to generate a one-time DPCM encoded sequence;
performing parallel subtraction operations Q times at most on the one-time DPCM encoded sequence to generate (R−1) multi-time DPCM encoded sequences, wherein P, Q and R are positive integers, P>1, 0<Q<P and R=1+P+P×(P−1)+ . . . +P×(P−1)×(P−2) . . . ×(P−Q+1); and
performing Huffman encoding on the one-time DPCM encoded sequence and the (R−1) multi-time DPCM encoded sequences to generate R Huffman encoded sequences.

9. The method according to claim 8, wherein the step of performing one-time DPCM encoding, multi-time DPCM encoding and Huffman encoding comprises further comprises:
attaching a header to the beginning of each of the R Huffman encoded sequences to form R image encoded packages.

10. The method according to claim 5, further comprising:
attaching a header to the beginning of the output encoded sequence to form an image encoded package according to the control signal.

11. An image encoding system for receiving a pixel sequence and generating an output encoded sequence, comprising:
a buffer for temporarily storing a predetermined number of pixels of the pixel sequence;
an encoding circuit coupled to the buffer for performing one-time DPCM encoding and multi-time DPCM encoding on the predetermined number of pixels to generate R Huffman encoded sequences;
a multiplexer coupled to the encoding circuit for selecting one sequence as the output encoded sequence from the R Huffman encoded sequences according to a control signal; and
a decision circuit for performing one-time DPCM encoding and multi-time DPCM encoding and performing accumulation of Huffman code lengths relating the predetermined number of pixels to generate the control signal;
wherein the control signal is generated before the R Huffman encoded sequences arrives at the multiplexer.

12. The system according to claim 11, wherein the encoding circuit comprises:
a first multi-time DPCM encoding device for receiving the pixel sequence, wherein the pixel sequence is split into P data sequences to be sent to the first multi-time DPCM encoding device and the first multi-time DPCM encoding device comprises:
a first one-time DPCM encoder for performing one-time DPCM encoding on the P data sequences to generate a first one-time DPCM encoded sequence; and
a first multi-time DPCM encoder string, which comprises Q multi-time DPCM encoders connected in series, for performing parallel subtractions Q times at most on the first one-time DPCM encoded sequence to generate (R−1) first multi-time DPCM encoded sequences, where P and Q are positive integers, P>1, 0<Q<P, R=1+P+P×(P−1)+ . . . +P×(P−1)×(P−2) . . . ×(P−Q+1); and
R Huffman encoders coupled to the first multi-time DPCM encoding device for performing Huffman encoding on the first one-time DPCM encoded sequence and the (R−1) first multi-time DPCM encoded sequences to generate the R Huffman encoded sequences.

13. The system according to claim 12, wherein each of the Huffman encoders further attaches a header to the beginning of the Huffman encoded sequence to form R image encoded packages.

14. The system according to claim 11, wherein the decision circuit comprises:
a second multi-time DPCM encoding device for receiving the pixel sequence, wherein the pixel sequence is split into P data sequences to be sent to the second multi-time DPCM encoding device and the second multi-time DPCM encoding device comprises:
a second one-time DPCM encoder for performing one-time DPCM encoding on the P data sequences to generate a second one-time DPCM encoded sequence; and
a second multi-time DPCM encoder string, which comprises Q multi-time DPCM encoders connected in series, for performing parallel subtraction operations Q times at most on the second one-time DPCM encoded sequence to generate (R−1) second multi-time DPCM encoded sequences, where P and Q are positive integers, P>1, 0<Q<P, R=1+P+P×(P−1)+ . . . +P×(P−1)×(P−2)× . . . ×(P−Q+1);
R Huffman code length calculators coupled to the second multi-time DPCM encoding device for performing accumulation of Huffman code lengths with respect to the second one-time DPCM encoded sequence and the (R−1) second one-time DPCM encoded sequences to generate the R code lengths; and
a comparator coupled to the R Huffman code length calculators for generating the control signal according to the R code lengths.

15. The system according to claim 11, further comprising:
a header attaching circuit coupled to the multiplexer for attaching a header to the beginning of the output encoded sequence to form an image encoded package.

16. The system according to claim 11, wherein the size of the buffer depends on the predetermined number of pixels and the processing rates of the encoding circuit and the decision circuit.

17. An image decoding system for receiving an image encoded package and generating an output pixel sequence, comprising:
a header detaching circuit for splitting the image encoded package into a header and an encoded sequence;
a Huffman decoder for performing Huffman decoding on the encoded sequence to generate a Huffman decoded sequence;
a multi-time DPCM decoding device for performing one-time DPCM decoding and (R−1) different kinds of multi-time DPCM decoding on the Huffman decoded sequence to generate a one-time DPCM decoded sequence and (R−1) multi-time DPCM decoded sequences, where R is a positive integer; and
a multiplexer for selecting one sequence as the output pixel sequence from the R DPCM decoded sequences according to the header.

18. The system according to claim 17, wherein the multi-time DPCM decoding device comprises:
a one-time DPCM decoder for performing one-time DPCM decoding on the Huffman decoded sequence to generate the one-time DPCM decoded sequence; and
(R−1) multi-time DPCM decoders connected in parallel for performing (R−1) different kinds of parallel addition operations Q times at most on the one-time DPCM decoded sequence to generate the (R−1) multi-time DPCM decoded sequences, where P and Q are positive integers, P>1, 0<Q<P, R=1+P+P×(P−1)+ . . . +P×(P−1)×(P−2)× . . . ×(P−Q+1).

19. An image decoding method for receiving an image encoded package and generating an output pixel sequence, comprising:
splitting the image encoded package into a header and an encoded sequence;
performing Huffman decoding on the encoded sequence to generate a Huffman decoded sequence;
performing one-time DPCM decoding and (R−1) different kinds of multi-time DPCM decoding on the Huffman decoded sequence to generate a one-time DPCM decoded sequence and (R−1) multi-time DPCM decoded sequences, where R is a positive integer; and
selecting one sequence as the output pixel sequence from the R DPCM decoded sequences according to the header.

20. The method according to claim 19, wherein the step of performing one-time DPCM decoding and (R−1) different kinds of one-time DPCM decoding and multi-time DPCM decoding comprises:
performing one-time DPCM decoding on the Huffman decoded sequence to generate the one-time DPCM decoded sequence; and
performing (R−1) different kinds of parallel addition operations Q times at most on the one-time DPCM decoded sequence to generate the (R−1) multi-time DPCM decoded sequences, where P and Q are positive integers, P>1, 0<Q<P, R=1+P+P×(P−1)+ . . . +P×(P−1)×(P−2)× . . . ×(P−Q+1).

21. The method according to claim 20, wherein the step of performing one-time DPCM decoding on the Huffman decoded sequence further comprises:
performing one-time DPCM decoding on the Huffman decoded sequence to generate the one-time DPCM decoded sequence according to a symbol-sharing differential pulse code demodulation method.

22. A method of multi-time differential pulse code modulation, comprising:
receiving P data sequences simultaneously;
performing one-time DPCM encoding on the P data sequences respectively to generate a one-time DPCM encoded sequence; and
performing parallel subtraction operations Q times at most on the one-time DPCM encoded sequence to generate (R−1) multi-time DPCM encoded sequences, where P, Q and R are positive integers, P>1, 0<Q<P, R=1+P+P×(P−1)+ . . . +P×(P−1)×(P−2)× . . . ×(P−Q+1).

23. The method according to claim 22, wherein the one-time DPCM encoding is a series of serial subtraction operations.

24. The method according to claim 22, wherein the step of performing one-time DPCM encoding further comprises:
performing one-time DPCM encoding on the P data sequences respectively to generate the one-time DPCM encoded sequence according to a symbol-sharing DPCM method.

25. A multi-time DPCM encoding device, comprising:
a one-time DPCM encoder for receiving P data sequences simultaneously, performing a series of serial subtraction operations on the P data sequences respectively and generating a one-time DPCM encoded sequence; and
a multi-time DPCM encoder string, which comprises Q multi-time DPCM encoders connected in series, for performing parallel subtraction operations Q times at most on the one-time DPCM encoded sequence to generate (R−1) multi-time DPCM encoded sequences, where P, Q and R are positive integers, P>1, 0<Q<P, R=1+P+P×(P−1)+ . . . +P×(P−1)×(P−2)× . . . ×(P−Q+1).

26. The device according to claim 25, wherein the one-time DPCM encoder is implemented using P symbol-sharing DPCM encoders connected in parallel.
